(19) United States
(12) Patent Application Publication
(10) Pub. No.: US 2014/0289861 A1
(43) Pub. Date: Sep. 25, 2014

(54) SYSTEM AND METHOD FOR PROVISIONING LICENSE KEYS

(71) Applicants: Marshal F. Savage, Austin, TX (US); Robert A. Contreras, Austin, TX (US); Vishwanath Jayaraman, Austin, TX (US)

(72) Inventors: Marshal F. Savage, Austin, TX (US); Robert A. Contreras, Austin, TX (US); Vishwanath Jayaraman, Austin, TX (US)

(21) Appl. No.: 13/847,822

(22) Filed: Mar. 20, 2013

(51) Int. Cl. G06F 21/10

(52) U.S. Cl. CPC G06F 21/105
USPC 726/26

(57) ABSTRACT

Systems and method for provisioning license keys are disclosed. The systems and methods may include receiving an entitlement data set from a license manager, the entitlement data set associated with a plurality of entitlements, receiving a host data set from an access controller, the host data set associated with a plurality of components, assigning a subset of the plurality of entitlements based at least on the host data set, communicating a binding data set to the license manager, the binding data set associated with the subset, and communicating a license data set to the access controller, the license data set based at least on the binding data.

### TECHNICAL FIELD

This invention relates generally to the field of information handling systems and more specifically to provisioning license keys.

### BACKGROUND

As the value and use of information continues to increase, individuals and businesses seek additional ways to process and store information. One option available to users is information handling systems (“information handling systems”). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the ubiquity of information handling systems increases, so does the number of information handling systems used by a particular enterprise. Each information handling system may require a number of firmware, hardware, and software licenses. Managing the volume of licenses may be burdensome and inefficient.

### SUMMARY OF THE DISCLOSURE

In accordance with certain embodiments of the present disclosure, systems and methods for provisioning license keys are disclosed. The systems and methods may include receiving an entitlement data set from a license manager, the entitlement data set associated with a plurality of entitlements, receiving a host data set from an access controller, the host data set associated with a plurality of components, assigning a subset of the plurality of entitlements based at least on the host data set, communicating a binding data set to the license manager, the binding data set associated with the subset, and communicating a license data set to the access controller, the license data set based at least on the binding data.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example system for provisioning license keys, in accordance with certain embodiments of the present disclosure;

FIG. 2 illustrates a flowchart of an example method for provisioning licenses to a new host information handling system of system, in accordance with certain embodiments of the present disclosure; and

FIG. 3 illustrates a flowchart of an example method for provisioning licenses for a new component of an existing host information handling system of system, in accordance with certain embodiments of the present disclosure.

### DETAILED DESCRIPTION OF THE INVENTION

For the purposes of this disclosure, an information handling system (“information handling system”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system (“IHS”) may include memory, one or more processing resources, such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Information handling systems may require a number of licenses in order to take advantage of any associated features. However, managing the licenses for an information handling system (particularly when it is one of a number in an enterprise environment) may be inefficient when done manually. One challenge that may arise in managing the licenses for a particular information handling system may be connectivity to a license management server. It may be inefficient and/or impossible to connect each information handling system to the license management server. It may also increase data security concerns due to an associated inability to establish a secure connection. Further, modern information handling systems may include a number of components with different licenses, increasing the complexity of license management both for initial provisioning and for later servicing. Indeed, licenses may be tied to a particular component identifier and if that component needs to be replaced, the license may need to be reprovisioned.

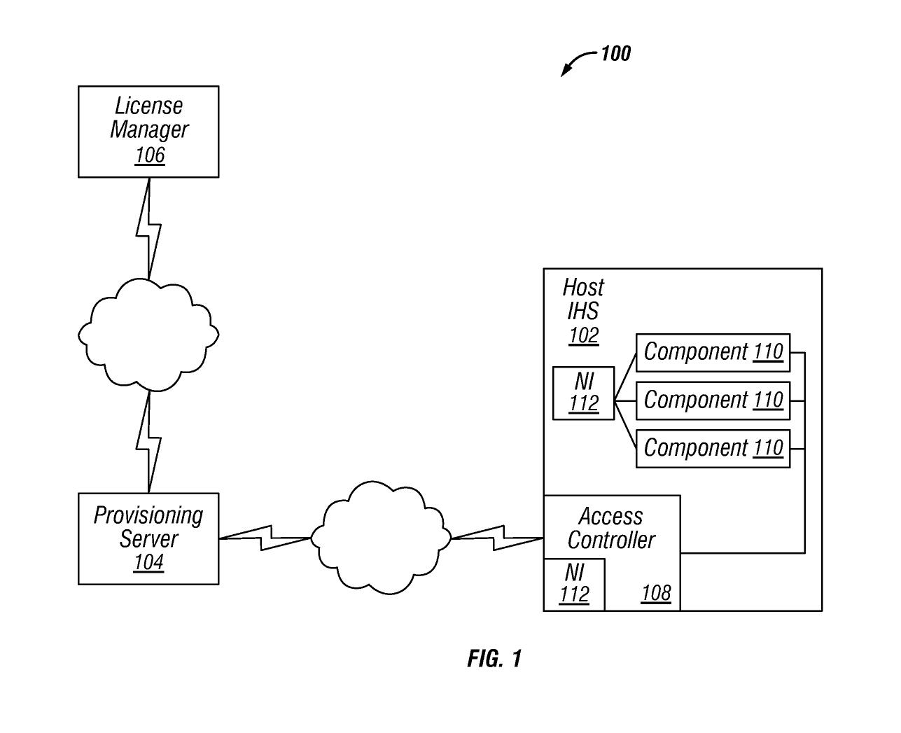

FIG. 1 illustrates an example system 100 for provisioning license keys, in accordance with certain embodiments of the present disclosure. System 100 may be configured to provide automated provisioning of license keys to certain components of system 100. For example, firmware license keys may be automatically provisioned. In configurations of system 100 in which an information handling system includes a plurality of licenses in a managed environment, it may be inefficient to manually manage all of the licenses associated with that information handling system.

In some embodiments, system 100 may include one or more host IHS 102 communicatively coupled to one or more provisioning server(s) 104. In the same or alternative embodiments, provisioning server 104 may be further communicatively coupled to license manager 106.

In some embodiments, license manager 106 may be one or more information handling systems located locally and/or remotely from provisioning server 104 and/or host IHS 102. License manager 106 may be configured to securely store license information, including keys, equipment identification data, entitlement data, and other license-related data. In some configurations of system 100, license manager 106 may be configured to securely store licensed-related data for a plurality of provisioning servers 104. For example, license manager 106 may be a cloud-based license management service such as that provided by Dell. License manager 106 may be communicatively coupled to provisioning server 104 via any appropriate communications network. For example, provisioning server 104 and license manager 106 may be configured to communicate via ethernet, cellular, and/or other appropriate communication network. In the same or alternative embodiments, provisioning server 104 and license manager 106 may be configured to communicate with one another via different communication networks.

In some embodiments, provisioning server 104 may be configured to communicate with license manager 106 over a secure connection. Once a secure connection is established, provisioning server 104 may be configured to communicate data to license manager 106 indicating the functions to which provisioning server 104 is allowed to provision (“entitlements”). Provisioning server 104 may be further configured to find and assign those entitlements to a particular host IHS 104 and/or a particular component 110 of host IHS 104. Provisioning server may be further configured to bind those entitlements to a particular host IHS 104 and/or a particular component 110 of host IHS 104 by communicating the device-specific data (e.g., MAC address, SAS address, etc.) to license manager 106. License manager 106 may, in some embodiments, return the license keys associated with the entitlements.

In some embodiments, provisioning server 104 may be further communicatively coupled to host IHS 102. Host IHS 102 may be communicatively coupled to provisioning server 104 via any appropriate communications network. For example, provisioning server 104 and host IHS 102 may be configured to communicate via ethernet, cellular, and/or other appropriate communication network. In the same or alternative embodiments, provisioning server 104 and host IHS 102 may be configured to communicate with one another via different communication networks.

In some embodiments, provisioning server 104 may be configured to communicate with host IHS 102 over a secure connection. For example, this connection may be established during an autodiscovery process. Provisioning server 104 may be further configured to communicate all necessary license keys to host IHS 102 for provisioning.

In some embodiments, host IHS 102 may include one or more network interface(s) (“NI”) 112, access controller 108, and a plurality of components 110. Network interface 112 may be configured to facilitate communication between host IHS 102 and provisioning server 104. For example, network interface 112 may be a network interface card (“NIC”). In other examples, network interface 112 may be hardware, software, firmware, or some combination thereof configured to facilitate communication between host IHS 102 and provisioning server 104.

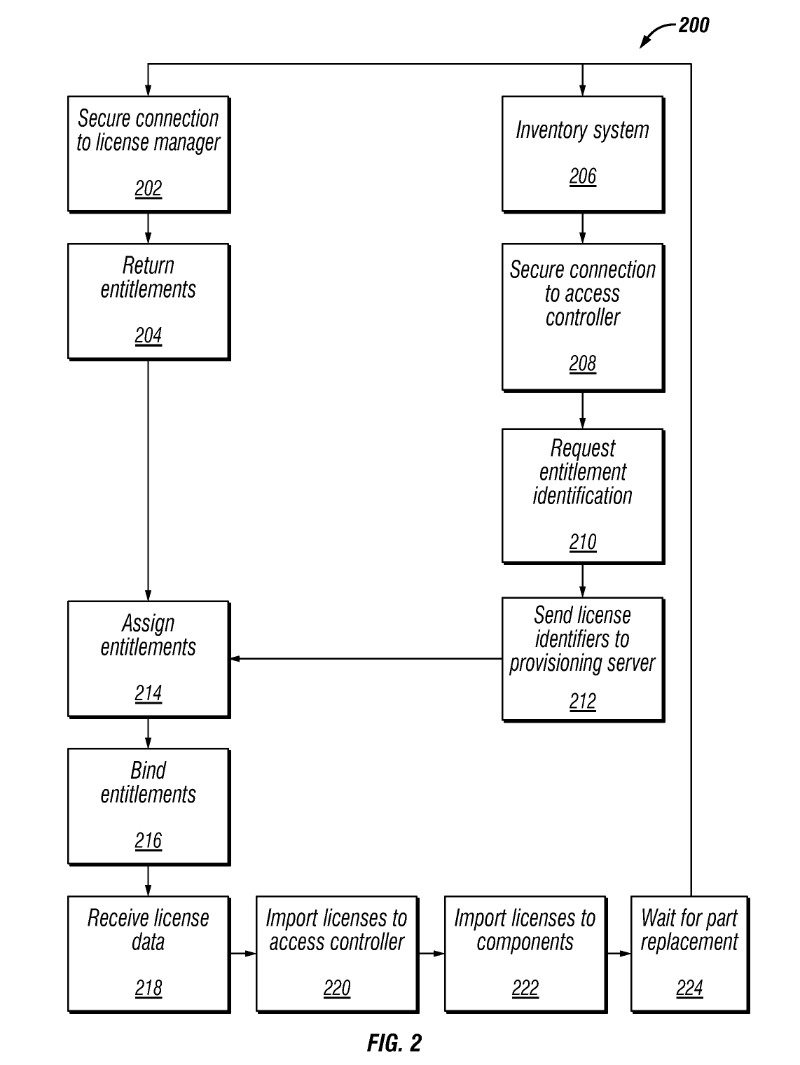

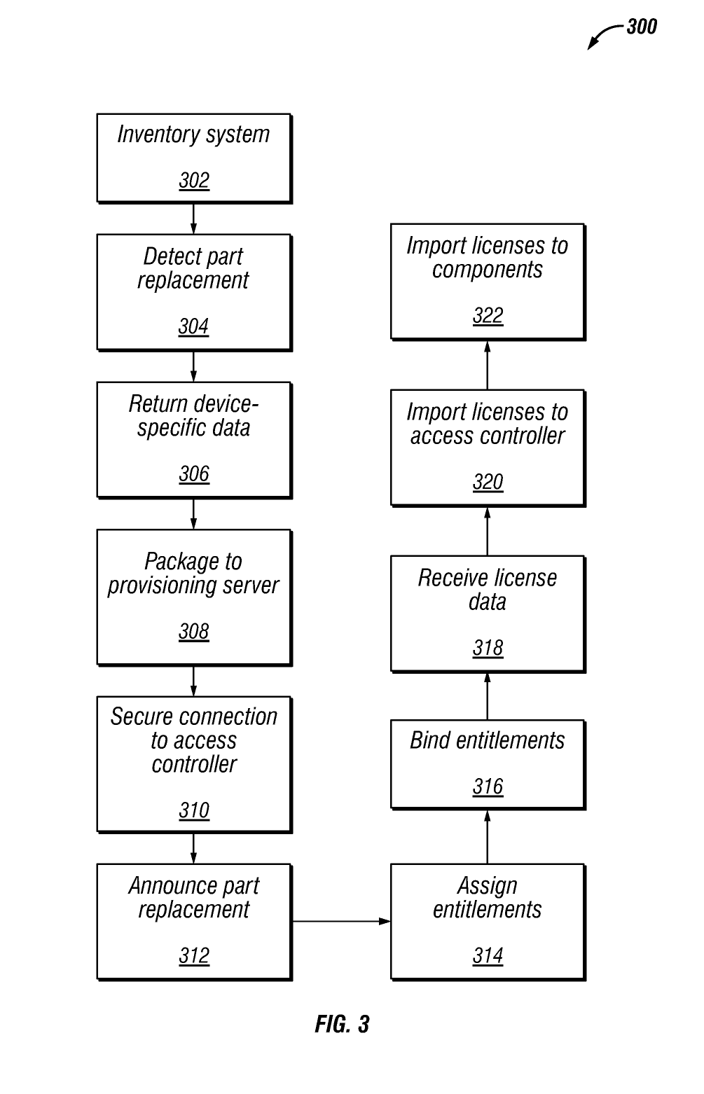

In some embodiments, network interface 112 may facilitate communication paths between components 110 of host IHS 102 and provisioning server 104, as well as between access controller 108 and provisioning server 104, as described in more detail below and with reference to FIGS. 2-3. For ease of illustration, system 100 is depicted as having two network interfaces 112. However, in some configurations, system 100 may have more or fewer network interfaces 112. For example, one network interface 112 may be configured to provide a plurality of communication paths between host IHS 102 and provisioning server 104.

As described above, network interface 112 may be configured to facilitate communication between components 110 of host IHS 102 and provisioning server 104. As described in more detail below and with reference to FIGS. 2-3, this communication path may be used to communicate license information between components 110 and provisioning server 104. In some embodiments, components 110 may be any components, subsystem, device, microchip, firmware, software, and/or any other component of host IHS 102 for which a license may be applicable as described in more detail below with reference to FIGS. 2-3. For example, components 110 may be a BIOS, IO/COMS firmware, and/or storage firmware.

As described above, network interface 112 may also be configured to facilitate communication between access controller 108 of host IHS 102 and provisioning server 104. As described in more detail below and with reference to FIGS. 2-3, this communication path may be used to communicate license information between access controller 108 and provisioning server 104. In some embodiments, access controller 108 may be hardware, software, firmware, and/or some combination thereof configured to mediate access to license information for components 110 of host IHS 102, as described in more detail below with reference to FIGS. 2-3.

In operation, host IHS 102, provisioning server 104, and license manager 106 may work together to automatically provision the appropriate licenses to host IHS 102 when host IHS 102 is new to system 100. Access controller 108 may be configured to mediate license information gathering and license importation for appropriate components 110 of host IHS 104, as described in more detail below with reference to FIGS. 2-3.

In some embodiments, access controller 108 may be configured to receive device-specific data from components 110 and communicate that data to provisioning server 104. In some configurations, the device-specific data may be, for example, the MAC address associated with a particular component 110 of host IHS 102, the SAS address associated with a particular component 110 of host IHS 102, and/or any other appropriate data configured to uniquely identify component 110 of host IHS 102. In some embodiments, obtaining device-specific data may be an automated process. This process may occur regularly at predetermined intervals, on-addition (e.g., when a new component 110 is added to host IHS 102), and/or on-demand. Access controller 108 may be further configured to communicate device-specific data to provisioning server 104.

Provisioning server 104 may then use that device-specific data to find and assign the entitlements that it had received from license manager 106. Provisioning server 104 may then bind the entitlements to the particular host IHS 104 and/or component(s) 110 by communicating the appropriate device-specific data to license manager 106. License manager 106 may then communicate license information to provisioning server 104. For example, license manager 106 may provide license keys for each appropriate host IHS 102 and/or component 110 of host IHS 102 to provisioning server 104. Provisioning server 104 may then import all appropriate licenses to access controller 108 of host IHS 102. Access controller 108 may then import the appropriate license(s) to the associated component 110 of host IHS 102.

Provisioning server 104 may be configured to receive license-related data from license manager 106 and securely and automatically provision the applicable licenses to components 110 via access controller 108.

Provisioning server 104, and license manager 106 may also work together to automatically provision the appropriate licenses to new components of host IHS 102 when an old component is replaced and/or when a new component is added. Access controller 108 may be configured to detect a replacement part as part of its system inventory, as described in more detail below with reference to FIGS. 2-3. Access controller 108 may be further configured to announce the new part to provisioning server 104. Provisioning server 104 may then communicate with access controller 108 to obtain the device-specific data before finding and assigning the appropriate entitlements.

Provisioning server 104 may then bind the appropriate entitlements with the new device-specific data and receive the associated license data (e.g., a license key) from license manager 106. Provisioning server 104 may then import the part replacement license to access controller 108, which may then import the appropriate licenses to the appropriate component(s) of host IHS 102.

FIG. 2 illustrates a flowchart of an example method 200 for provisioning licenses to a new host IHS 102 of system 100, in accordance with certain embodiments of the present disclosure. Method 200 may include obtaining entitlements, obtaining device-specific data, binding entitlements, and importing the appropriate licenses.

According to one embodiment, method 200 may begin at step 202 and/or step 206. Teachings of the present disclosure may be implemented in a variety of configurations. As such, the preferred initialization point for method 200 and the order of steps 202-224 comprising method 200 may depend on the implementation chosen.

At step 202, method 200 may establish a secure connection in order to receive the appropriate entitlements, as described in more detail above with reference to FIG. 1. For example, provisioning server 104 may establish a secure communication link with license manager 106 in order to receive the entitlements. After establishing the secure connection, method 200 may proceed to step 204, where the entitlements are returned, as described in more detail above with reference to FIG. 1. After receiving the entitlements, method 200 may proceed to step 214. In some implementations of method 200, steps 206-212 may occur before, after, and/or at the same time as steps 202-204. As a result, it may aid understanding to discuss those first.

At step 206, method 200 may obtain device-specific data from one or more component(s) 110 of host IHS 104, as described in more detail above with reference to FIG. 1. For example, a BIOS, IO/COMS firmware, and/or other firmware may publish device-specific data to access controller 108 of host IHS 102. In some configurations, the device-specific data may be, for example, the MAC address associated with the particular component 110 of host IHS 102. In some embodiments, obtaining device-specific data may be an automated process. This process may occur regularly at predetermined intervals, on-addition (e.g., when a new component 110 is added to host IHS 102), and/or on-demand. After obtaining device-specific data, method 200 may proceed to step 208.

At step 208, method 200 may automatically establish a secure connection for communicating device-specific data, as described in more detail above with reference to FIG. 1. For example, access controller 108 may announce itself to provisioning server 104 and receive an auto-discovery handshake from provisioning server 104. After establishing the secure connection, method 200 may proceed to step 210.

At step 210, method 200 may request license identifiers, as described in more detail above with reference to FIG. 1. For example, provisioning server 104 may request entitlement identification from access controller 108 of host IHS 102. This may include an identification of the appropriate licenses for provisioning. After requesting the identification, method 200 may proceed to step 212.

At step 212, method 200 may send license identifiers to provisioning server 104, as described in more detail above with reference to FIG. 1. For example, access controller 108 of host IHS 102 may return license identifiers identifying the device (e.g., through device-specific data) as well as the appropriate license to provisioning server 104. Once these license identifiers are returned, method 200 may proceed to step 214.

At step 214, method 200 may use the entitlements returned at step 204 and the license identifiers returned at step 212 to find and assign entitlements, as described in more detail above with reference to FIG. 1. For example, provisioning server 104 may find and assign the appropriate entitlements associated with host IHS 104. Once the entitlements have been assigned, method 200 may proceed to step 216.

At step 216, method 200 may bind the entitlements, as described in more detail above with reference to FIG. 1. For example, provisioning server 104 may communicate with license manager 106 in order to bind the appropriate entitlements to the appropriate component(s) 110 of host IHS 102. This may include communicating a mapping of the appropriate device-specific data and the associated license identifiers. After binding the entitlements, method 200 may proceed to step 218.

At step 218, method 200 may receive license data, as described in more detail above with reference to FIG. 1. For example, provisioning server 104 may receive from license manager 106 license keys specific to a particular component 110 of host IHS 104. After receiving the licenses, method 200 may proceed to step 220.

At step 220, method 200 may import all licenses, as described in more detail above with reference to FIG. 1. For example, provisioning server 104 may communicate all appropriate license data to access controller 108 of host IHS 102. This may include, for example, all appropriate license keys for host IHS 102. After importing all appropriate licenses, method 200 may proceed to step 222.

At step 222, method 200 may provision the appropriate licenses to the associated component(s) 110 of host IHS 104, as described in more detail above with reference to FIG. 1. For example, access controller 108 may import the appropriate license to each of a BIOS, IO/COMS firmware, and/or other appropriate firmware device. After this import, method 200 may proceed to step 224.

At step 224, method 200 may wait for part replacement, as described in more detail above with reference to FIG. 1 and below with reference to FIG. 3. For example, host IHS 102 may inventory its set of components 110 in order to determine if and/or when a replacement component 110 appears, at which point host IHS 102 may announce the presence of a new component 110. Once a new component 110 has been discovered and appropriate data gathered, method 200 may return to steps 202 and/or 206 in order to provision appropriate licenses for the new component 110.

Although FIG. 2 discloses a particular number of steps to be taken with respect to method 200, method 200 may be executed with more or fewer steps than those depicted in FIG. 2. In addition, although FIG. 2 discloses a certain order of steps comprising method 200, the steps comprising method 200 may be completed in any suitable order. For example, method 200 may begin at step 206, step 202, and/or some combination thereof. Depending on the configuration of system 100, some steps may take place simultaneously. Further, in some configurations of method 200, host IHS 102 may not wait for part replacement, as described in more detail above with reference to step 224 and below with reference to FIG. 3. Still further, in some configurations of method 200, method 200 may return to its beginning steps following execution of step 218.

FIG. 3 illustrates a flowchart of an example method 300 for provisioning licenses for a new component 110 of an existing host IHS 103 of system 100, in accordance with certain embodiments of the present disclosure. Method 300 may include detecting part replacement, announcing part replacement, obtaining device-specific data, binding entitlements, and importing the appropriate licenses. The steps of method 300 may generally correspond to step 224 of method 200, as described in more detail above with reference to FIG. 2.

According to one embodiment, method 300 may begin at step 302. Teachings of the present disclosure may be implemented in a variety of configurations. As such, the preferred initialization point for method 300 and the order of steps 302-33 comprising method 300 may depend on the implementation chosen.

At step 302, method 300 may obtain device-specific data from one or more component(s) 110 of host IHS 104, as described in more detail above with reference to FIG. 1. For example, a BIOS, IO/COMS firmware, and/or other firmware may publish device-specific data to access controller 108 of host IHS 102. In some configurations, the device-specific data may be, for example, the MAC address associated with the particular component 110 of host IHS 102. After receiving the device-specific data, method 300 may proceed to step 304.

At step 304, method 300 may detect a new component 110 of host IHS 102, as described in more detail above with reference to FIG. 1. In some embodiments, obtaining device-specific data may be an automated process. This process may occur regularly at predetermined intervals, on-addition (e.g., when a new component 110 is added to host IHS 102), and/or on-demand. After obtaining device-specific data, method 300 may proceed to step 306.

At step 306, method 300 may return device-specific data, as described in more detail above with reference to FIGS. 1-2. For example, access controller 108 may receive data specific to each of the components 110. For example, this may include receiving the MAC address, SAS address, and/or appropriate device-specific information configured to identify the appropriate component 110 to access controller 108. After receiving the device-specific data, method 300 may proceed to step 308.

At step 308, method 300 may package all applicable device-specific data for communication to provisioning server 104, as described in more detail above with reference to FIG. 1. For example, access controller 108 may bundle all appropriate device-specific data received from various component(s) 110 for communication to provisioning server 104. After packaging the data, method 300 may proceed to step 310.

At step 310, method 300 may automatically establish a secure connection for communicating device-specific data, as described in more detail above with reference to FIG. 1. For example, access controller 108 may receive an auto-discovery handshake from provisioning server 104 in response to the announcement regarding the new component 110 of host IHS 102. After establishing the secure connection, method 300 may proceed to step 312.

At step 312, method 300 may announce that a component 110 of host IHS 102 was replaced, as described in more detail above with reference to FIG. 1. For example, access controller 108 of host IHS 102 may communicate to provisioning server 104 that a new component 110 of host IHS 102 was detected. After making the announcement, method 300 may proceed to step 314.

At step 314, method 300 may use the entitlements returned at step 304 and the license identifiers returned at step 312 to find and assign entitlements, as described in more detail above with reference to FIG. 1. For example, provisioning server 104 may find and assign the appropriate entitlements associated with host IHS 104. Once the entitlements have been assigned, method 300 may proceed to step 316.

At step 316, method 300 may bind the entitlements, as described in more detail above with reference to FIG. 1. For example, provisioning server 104 may communicate with license manager 106 in order to bind the appropriate entitlements to the appropriate component(s) 110 of host IHS 102. This may include communicating a mapping of the appropriate device-specific data and the associated license identifiers. After binding the entitlements, method 300 may proceed to step 318.

At step 318, method 300 may receive license data, as described in more detail above with reference to FIG. 1. For example, provisioning server 104 may receive from license manager 106 license keys specific to a particular component 110 of host IHS 104. After receiving the licenses, method 300 may proceed to step 330.

At step 320, method 300 may import all licenses, as described in more detail above with reference to FIG. 1. For example, provisioning server 104 may communicate all appropriate license data to access controller 108 of host IHS 102. This may include, for example, all appropriate license keys for host IHS 102. After importing all appropriate licenses, method 300 may proceed to step 322.

At step 322, method 300 may provision the appropriate licenses to the associated component(s) 110 of host IHS 104, as described in more detail above with reference to FIG. 1. For example, access controller 108 may import the appropriate license to each of a BIOS, IO/COMS firmware, and/or other appropriate firmware device. After this import, method 300 may return to steps 302 and/or 306.

Although FIG. 3 discloses a particular number of steps to be taken with respect to method 300, method 300 may be executed with more or fewer steps than those depicted in FIG. 3. In addition, although FIG. 3 discloses a certain order of steps comprising method 300, the steps comprising method 300 may be completed in any suitable order. For example, method 300 may also include steps directed toward periodic checks to ensure that an old version of component 110 of host IHS 102 has been removed. Further, although steps 216-218 are depicted as following steps 20-214, in some configurations this step may come before or during the preceding steps.

What is claimed:

1. An information handling system for provisioning licenses, the system comprising:
a network interface communicatively coupled to a provisioning server;
an access controller communicatively coupled to the network interface, the access controller configured to:
receive a device data set from a component communicatively coupled to the access controller;
communicate a host data set to the provisioning server, the host data set based at least on the device data set;
receive a license data set from the provisioning server, the license data set identified based at least on the host data set; and
import a component license data set to the component, the component license data set being part of the license data set.

2. The system of claim 1, wherein the component license data set comprises a license key.

3. The system of claim 1, wherein the device data set comprises a MAC address of the component.

4. The system of claim 1, wherein the access controller is further configured to automatically announce itself to the provisioning server.

5. The system of claim 1, wherein the access controller is further configured to detect a replacement component.

6. The system of claim 5, wherein the access controller is further configured to announce the replacement component to the provisioning server.

7. An information handling system for provisioning licenses, the system comprising:
a processor;
a memory communicatively coupled to the processor, the memory having stored thereon instructions that when read and executed cause the processor to:
receive an entitlement data set from a license manager, the entitlement data set associated with a plurality of entitlements;
receive a host data set from an access controller, the host data set associated with a plurality of components;
assign a subset of the plurality of entitlements based at least on the host data set;
communicate a binding data set to the license manager, the binding data set associated with the subset; and
communicate a license data set to the access controller, the license data set based at least on the binding data.

8. The system of claim 7, wherein the license data set comprises a plurality of license keys.

9. The system of claim 7, wherein the host data set comprises a plurality of component identifiers.

10. The system of claim 9, wherein the plurality of component identifiers comprises a plurality of MAC addresses.

11. The system of claim 7, wherein the instructions, when read an executed, further cause the processor to recognize the access controller when the access controller automatically announces itself to the provisioning server.

12. The system of claim 7, wherein the instructions, when read an executed, further cause the processor to recognize an announcement from the access controller, the announcement associated with a replacement component.

13. The system of claim 7, wherein the entitlement data set comprises entitlements associated with a plurality of firmware licenses.

14. A method for provisioning licenses, the method comprising:
receiving an entitlement data set from a license manager, the entitlement data set associated with a plurality of entitlements;
receiving a host data set from an access controller, the host data set associated with a plurality of components;
assigning a subset of the plurality of entitlements based at least on the host data set;
communicating a binding data set to the license manager, the binding data set associated with the subset; and
communicating a license data set to the access controller, the license data set based at least on the binding data.

15. The method of claim 14, wherein the license data set comprises a plurality of license keys.

16. The method of claim 14, wherein the host data set comprises a plurality of component identifiers.

17. The method of claim 16, wherein the plurality of component identifiers comprises a plurality of MAC addresses.

18. The method of claim 14, further comprising recognizing the access controller when the access controller automatically announces itself to the provisioning server.

19. The method of claim 14, further comprising recognizing an announcement from the access controller, the announcement associated with a replacement component.

20. The method of claim 14, wherein the entitlement data set comprises entitlements associated with a plurality of firmware licenses.
